(19) United States
(12) Patent Application Publication
(10) Pub. No.: US 2002/0122312 A1
(43) Pub. Date: Sep. 5, 2002

(54) Vehicle headlight comprising improved means for fastening the lense

(76) Inventors: Sebastien Berne, Montbeliard (FR); Caroline Riviere, Valentigney (FR)

Correspondence Address: YOUNG & THOMPSON, 745 SOUTH 23RD STREET 2ND FLOOR, ARLINGTON, VA, 22202

(21) Appl. No.: 10/067,400

(22) Filed: Feb. 7, 2002

(30) Foreign Application Priority Data
Feb. 8, 2001 (FR) 0101729

(51) Int. Cl. F21V 15/04; F21V 17/16

(52) U.S. Cl. 362/546; 362/267; 362/390; 362/374

(57) ABSTRACT

Optical unit for an automotive vehicle, comprising a housing (5) suitable for being integral with a structural or bodywork element (2) of a vehicle, said housing (5) defining an interior and a main opening (13) facing the vehicle exterior, and a glass (15) suitable for being fixed to the housing (5) such as to close off at least partially said main opening (13) by means of fastening members (21, 22, 31, 32). The fastening members (21, 22, 31, 32) join the glass (15) together with the housing (5) with a substantially axial play relative to the vehicle axis, the play being defined between a normal working position and a retracted position of the glass (15).

The invention relates to an optical unit for an automotive vehicle, comprising a housing suitable for being integral with a structural or bodywork element of a vehicle, said housing defining an interior and a main opening facing the vehicle exterior, and a glass suitable for being fixed to the housing such as to close off at least partially said main opening by means of fastening members.

In optical units of known type, the glass is generally held on the housing either by gluing or by means of metal clips, so that the fastening of the glass on the housing is a substantially play-free fastening.

When a vehicle equipped with such an optical unit is in collision with a pedestrian, it has been discovered that the impact of the optical unit itself was the cause of injuries to the pedestrian, especially at pelvic level.

A main object of the invention is to minimize the risks of injuries due to the impact of the optical unit on the pedestrian.

To this end, an optical unit according to the invention is characterized in that the fastening members join the glass together with the housing with a substantially axial play relative to the vehicle axis, the play being defined between a normal working position and a retracted position of the glass, and the fastening members comprise at least one pair of detachable complementary latching members, formed in one piece with the housing and the glass respectively and releasable by elastic deformation of one at least of said members.

By virtue of this arrangement, the optical unit contributes to the absorption of energy in a collision with a pedestrian.

According to other characteristics of the invention:

the axial play of the glass relative to the housing is greater than 40 millimeters;

the optical unit comprises an elastic seal which, when the glass is fixed on the housing, cooperates with peripheral surfaces of the glass and of the housing, and which is subjected to a substantially axial stress, so that it elastically returns the glass into its normal working position;

said complementary latching members are suitable for defining an axial stop when they are joined, the glass being able to detached substantially axially from the housing when they are disengaged;

one of the latching members of said pair is a rigid member, whereas the other is an elastic member;

the fastening members comprise a plurality of pairs of complementary latching members, said latching members being distributed over peripheral regions of the housing and of the glass; and

one pair of latching members comprises a female member configured as a catch and a male member configured as a hook fastening prone to slide in the catch.

The invention also relates to a front face of an automotive vehicle containing an optical unit of the type previously described.

Finally, the invention relates to an automotive vehicle equipped with such an optical unit.

An embodiment of the invention will now be described with reference to the appended drawings, in which:

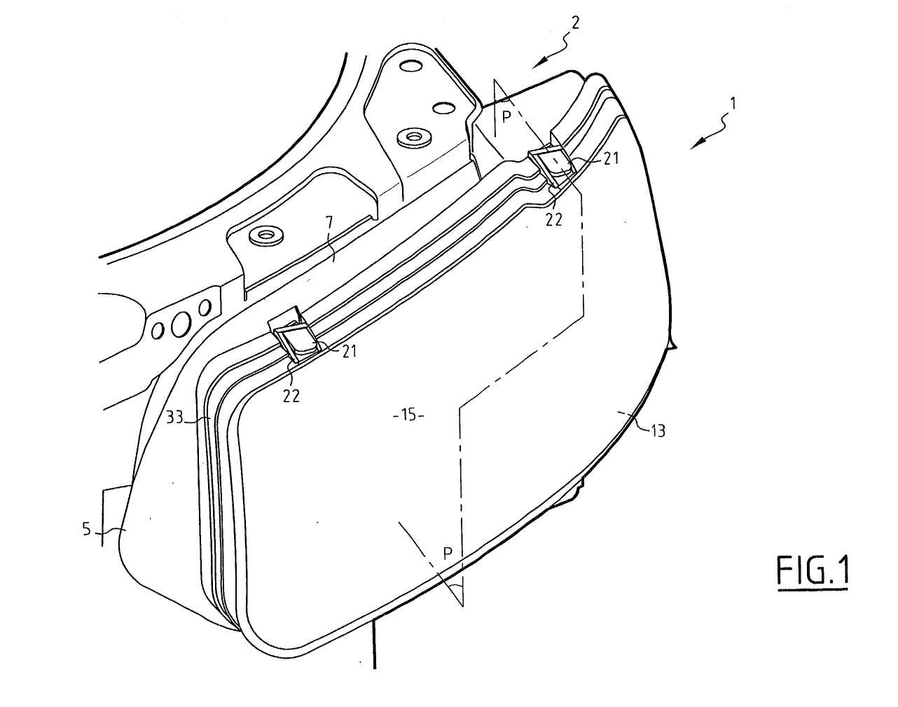

FIG. 1 is a front projection of an optical unit according to the invention and of a section of the vehicle front face, with which the optical unit is integral;

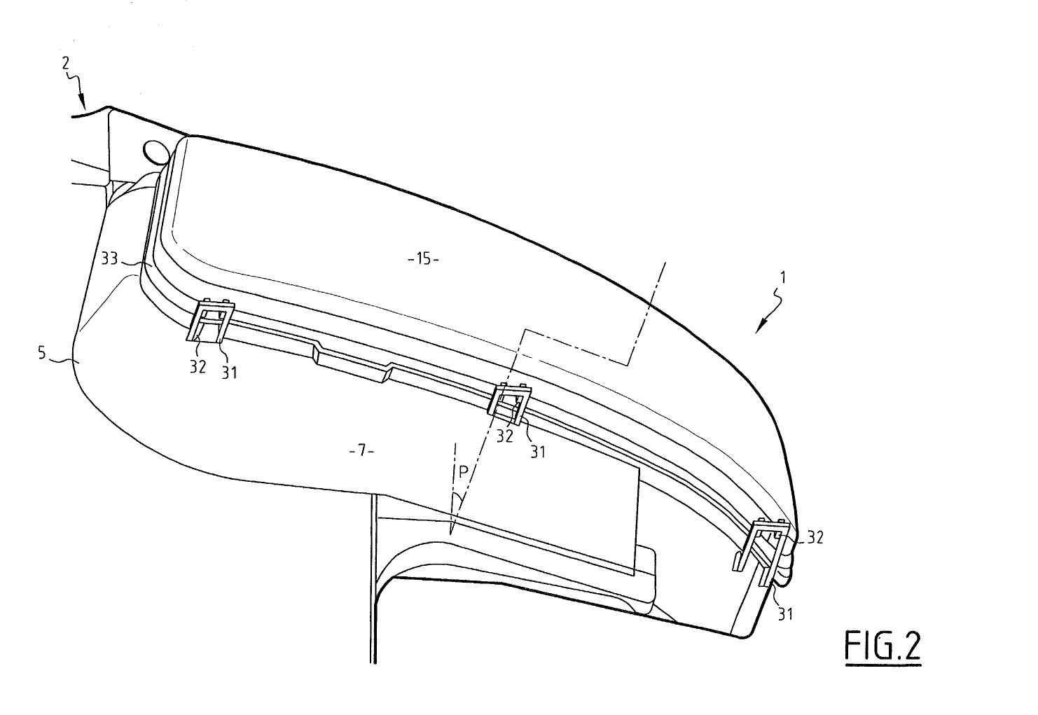

FIG. 2 is an analogous view showing a lower section of the optical unit represented in FIG. 1;

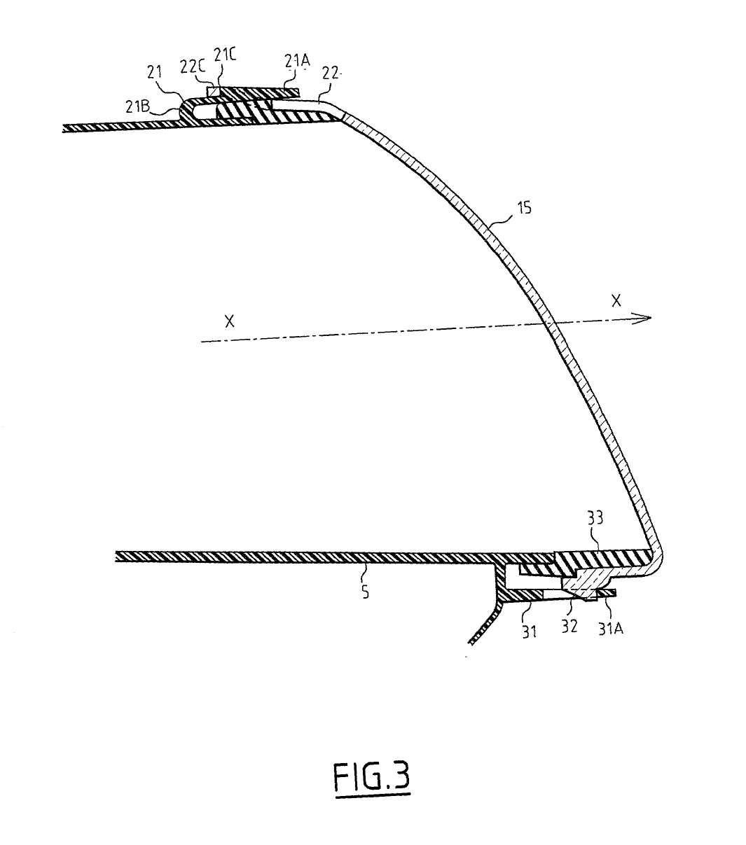

FIG. 3 is a sectional view of the optical unit of the previous figures, in the plane P represented in these figures, in its normal working position; and

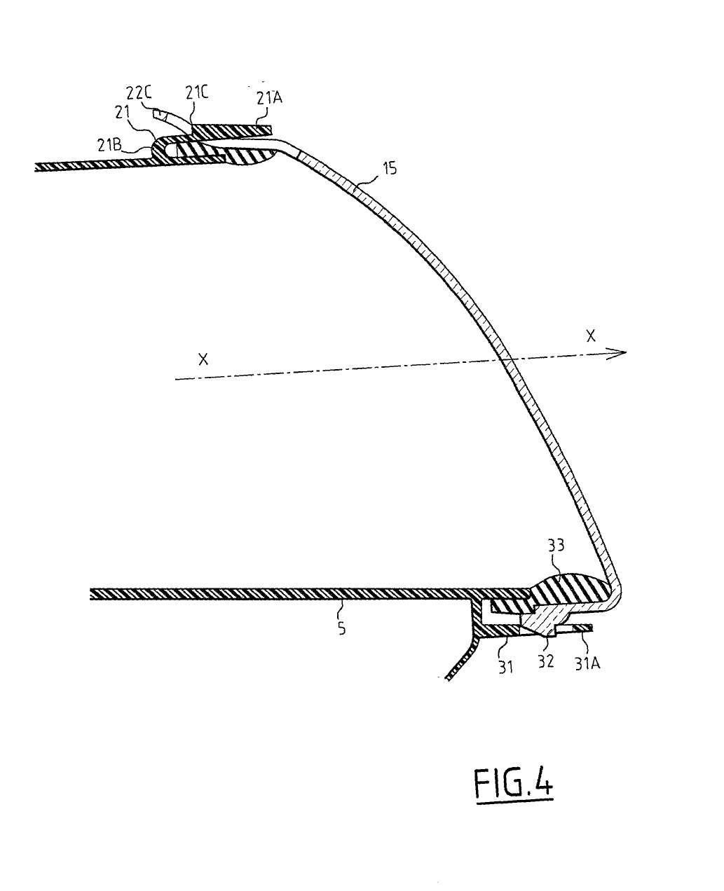

FIG. 4 is an analogous view in the retracted position of the glass.

FIGS. 1 and 2 show a front optical unit 1, mounted and fixed on a front face section 2 of an automotive vehicle.

In order to simplify the following description, the optical unit will be orientated relative to its working arrangement on the vehicle and the terms “front”, “rear”, “lower”, “upper” will be understood according to the longitudinal axis X-X of the vehicle (see FIG. 3).

Traditionally, a front optical unit 1 of this type comprises a housing 5, integrated by complementarity of form in the front face 2 of the vehicle. This housing 5 is either mounted directly on the front face 2, in which case it contains on its periphery means for fastening to the front face 2, or is realized in one piece with the front face 2 or with other bodywork or structural elements of the vehicle.

The invention can be similarly conceived for an optical unit disposed elsewhere on the vehicle, for example at the rear.

The housing 5 has a peripheral skirt 7 and a back, situated on the engine compartment side and integrated in the front face 2, which define an interior of the housing 5. The housing 5 has a frontal opening 13 constituting its main opening, facing the vehicle exterior, opposite to the back of the housing, and giving access to the interior of this housing.

The optical unit 1 contains, on the other hand, a glass 15 fixed on the housing 5 such as to close off the opening 13.

The optical unit 1 comprises, on the other hand, headlamp elements, constituted for example by lamps, lamp holders and reflectors, which are fixed in the interior of the housing 5 and which have not here been represented.

The means for fastening the glass 15 on the housing 5 are constituted by pairs of complementary latching members 21, 22 (FIG. 1), 31, 32 (FIG. 2).

First members 21, 31 are formed in one piece with the housing 5, projecting frontward from the latter, close to the opening 13.

A corresponding number of second members 22, 32 are formed in one piece with the glass 15 and distributed over the periphery of the latter, opposite first members 21, 31.

The pairs of complementary latching members 21, 22, 31, 32, represented in FIGS. 1 and 2 as being five in number, constitute releasable fastening means, so that a user, from the vehicle exterior and without passing through another access, in particular arranged in the engine compartment, is able to detach the glass 15 from the housing 5. The user can thus carry out the replacement or maintenance of headlamps placed inside the housing 5.

In order to realize the seal-tightness between the inside and outside of the housing 5, a peripheral seal 33 is provided, interposed between the housing 5 and the glass 15. When the glass 15 is fixed on the housing 5, the seal 33 undergoes axial compression, in a direction corresponding to the direction of latching of complementary pairs of members 21, 22, 31, 32.

As will be more clearly apparent in FIG. 3, the fastening members 21, 22, 31, 32 are releasable by elastic deformation.

The latching members 21 formed on the upper section of the housing 5 are constituted by elastic lugs, the front section 21A of which is free, whereas the rear section 21B is connected to the housing such as to form an articulation allowing a certain spring movement of the front section 21A. In an intermediate section, the lug 21 contains a vertical stop surface 21C.

The complementary latching member 22, formed on the upper section of the glass 15, is constituted by a shackle having a bar 22C, which bar faces toward the rear and is suitable for engaging on the intermediate section 21C of the lug 21. These two sections form an axial stop along the axis X-X represented in the figure, orientated from rear to front, that is to say directed from the inside to the outside of the housing, and passing through the main opening 13. Thus, when these complementary latching members 21, 22 are engaged as represented in FIG. 3, they prevent the glass 15 from being withdrawn from the housing 5 along the axis X-X. In this position, since the lug 21 is free from spring movement in the shackle 22, a user can very easily maneuver the lug 21 by bearing on its front section 21A and thus mutually disengaging the two complementary members, before proceeding to withdraw the glass 15 from the housing 5.

The latching member 31 formed on the lower section of the housing 5 is constituted, conversely, by a shackle having a frontward-projecting transverse bar 31A.

The complementary latching member 32 formed on the lower section of the glass 15 is formed by a hook fastening engaging in the shackle 31 so as to form with the bar 31A an axial stop. The shackle 31 is prone to spring movement by elastic deformation such that it can be disengaged from the hook fastening 32, its rest position corresponding to its position of engagement with the hook fastening 32.

In this configuration, each pair of latching members is composed of a female member or catch 22, 31 and a male member or hook fastening 21, 32. The hook fastening 21, 32 is prone to slide in the catch 22, 31, so that the glass 15 is fixed on the housing 5 with an axial play along an axis X-X between a normal working position, such as represented in FIG. 3, and a retracted position of the glass 15, such as represented in FIG. 4.

Preferably, the axial play of the glass 15 relative to the housing 5 is greater than 40 millimeters.

FIG. 4 shows the optical unit 1 in a retracted position of the glass 15, a position obtained under the effect of an impact of the glass 15 on an obstacle (for example a pedestrian). As can be seen, the hook fastenings 21, 32 have described a sliding movement in the catches 22, 31, from the position represented in the previous figure, counter to an elastic return force created by the seal 33. In the retracted position of the glass 15, such as represented in FIG. 4, the seal 33 is compressed between the glass 15 and a peripheral edge of the housing 5, so that it exerts a substantially axial elastic return force upon the glass 15 toward its normal working position represented in FIG. 3.

It is clear that, in the event of collisions exceeding a certain intensity threshold, the axial play of the glass 15 relative to the housing 5 and the compression of the seal 33 are insufficient to absorb the total shock energy, so that the catches are led to break prior to the complete breakage of the glass 15 when it bangs against the housing 5 over the whole of its periphery.

Given the nature of the materials generally used to realize the housings 5 and the glasses 15, the latching members prone to spring movement are those 21, 31 which are formed on the housing 5, whereas the complementary latching members 22, 32 formed on the glass 15 are rigid or virtually rigid, that is to say that their deformation is not significant in the joining or release of the latching members.

The invention which has just been described allows the realization of an optical unit capable of helping to absorb shock energy and thus of preventing certain injuries to a pedestrian struck by a vehicle equipped with such an optical unit.

The absorption of shocks by such an optical unit, within the limit of a certain intensity, meets the increasing demands aimed at protecting pedestrians from vehicles.

1. Optical unit for an automotive vehicle, comprising a housing (5) suitable for being integral with a structural or bodywork element (2) of a vehicle, said housing (5) defining an interior and a main opening (13) facing the vehicle exterior, and a glass (15) suitable for being fixed to the housing (5) such as to close off at least partially said main opening (13) by means of fastening members (21, 22, 31, 32), characterized in that said fastening members (21, 22, 31, 32) join the glass (15) together with the housing (5) with a substantially axial play relative to the vehicle axis, the play being defined between a normal working position and a retracted position of the glass (15), and the fastening members (21, 22, 31, 32) comprise at least one pair of detachable complementary latching members, formed in one piece with the housing (5) and the glass (15) respectively and releasable by elastic deformation of one at least (21, 31) of said members.

2. Optical unit according to claim 1, characterized in that the axial play of the glass (15) relative to the housing (5) is greater than 40 millimeters.

3. Optical unit according to claim 1 or 2, characterized in that it comprises an elastic seal (33) which, when the glass (15) is fixed on the housing (5), cooperates with peripheral surfaces of the glass (15) and of the housing (5), and which is subjected to a substantially axial stress, so that it elastically returns the glass (15) into its normal working position.

4. Optical unit according to any one of claims 1 to 3, characterized in that said complementary latching members (21, 22, 31, 32) are suitable for defining an axial stop when they are joined, the glass (15) being able to detached substantially axially from the housing (5) when they are disengaged.

5. Optical unit according to any one of claims 1 to 4, characterized in that one (22, 32) of the latching members (21, 22, 31, 32) of said pair is a rigid member, whereas the other is an elastic member (21, 31).

6. Optical unit according to any one of claims 1 to 5, characterized in that the fastening members (21, 22, 31, 32) comprise a plurality of pairs of complementary latching members, said latching members being distributed over peripheral regions of the housing (5) and of the glass (15).

7. Optical unit according to any one of claims 1 to 6, characterized in that one pair of latching members comprises a female member (22, 31) configured as a catch and a male member (21, 32) configured as a hook fastening prone to slide in the catch.

8. Front face of an automotive vehicle, equipped with an optical unit according to any one of claims 1 to 7.

9. Automotive vehicle equipped with an optical unit according to any one of claims 1 to 7.
